(19) United States
(12) Patent Application Publication
(10) Pub. No.: US 2007/0061762 A1
(43) Pub. Date: Mar. 15, 2007

(54) Method for formatting and producing custom-printed indicia

(76) Inventor: Chris Hymel, Rosharon, TX (US)

Correspondence Address: DAVID G. HENRY, 2809 Creek Side Drive, Edmond, OK, 73003, US

(21) Appl. No.: 11/202,418

(22) Filed: Aug. 10, 2005

(51) Int. Cl. B42D 15/00

(52) U.S. Cl. 715/866; 273/293; 493/320; 283/117

(57) ABSTRACT

The proposed invention is an easy and economical method to make customized playing cards; the preferred embodiment allows the user complete control over the layout of each card to create cards for traditional poker card decks, for other games or brand new games, and to create personalized (playing) cards where the front of the cards contains various pictures as specified by the user, e.g., pictures of one's children, sports team, etc. The back of the card can also display any image desired. The proposed invention also allows the user to share individual “Card Layouts” and entire “Deck Layouts” with any other user, or upload to a commercial printer for special printing needs. For typical customization, special micro-perforated card stock may be used in user's own printer. Also, in the preferred embodiment, an alignment template is included to calibrate and facilitate alignment of each individual printer output to the card stock.

### BACKGROUND OF THE INVENTION

1. Field of the Invention

Applicant's invention relates to production of consumer-selected and formatted media bearing printed, digital images.

2. Background Information

The origin of modern playing cards may be traced to China in 969 from “domino cards.” In the 1100s, the Chinese began playing “cards” by shuffling paper dominoes. Card decks with four suits and court cards came from the Islamic empire and were imported by Europeans around 1370—before the advent of the printing press or woodcuts. As such, all playing cards were each hand made and hand painted and thus, scarce and only available to the very wealthy. However, mass production was soon available thereafter.

Modern day cards can be directly traced to the card designs from the French, and they are credited with spreading the pleasures of card playing worldwide. Americans began making their own cards about 2 centuries ago, and subsequently refined the cards, e.g., double-headed court cards (so the card can be read no matter how it is held upright), varnished surfaces (for longevity and ease in shuffling), rounded corners (to reduce typical wear and tear in daily playing), and the advent of the Joker.

Alongside the evolution of various designs of the play side faces of playing cards, in most countries there have been efforts to produce more illustrative cards with artistic undertones, or for purposes other than simple card-playing (such as promotional cards bearing a company's logo). However, to date, there are no economical and simple means to customize the faces or fronts of playing cards, nor are there any commercially available packages or templates to allow for even an end-user to customize the appearance of playing cards, much less for doing so with respect to both the front and back sides of each card. This is true, despite the proliferation of many consumer-level, computer-based, photo and image printing packages.

3. Background Art

The known prior art does not teach simple and economical means to customize playing cards with user-selected images. Current, economically feasible commercial processes for customizing playing cards require a minimum in the thousands of units per order, or require the use of complicated templates operating under an existing graphics or desktop publishing application packages.

There are adverse considerations associated with the use of a template operating under an existing graphics or desktop publishing application packages. These include 1) cost to obtain the application package, 2) need of the user to be familiar with the intended use of the package, 3) non-intuitive/“awkward” use of the template for the specific task (card creations) as any template must conform to the constraints of the application package, 4) customization not optimized to accomplish the specific task (card creation), 5) lack of specific printer alignment/calibration unique to card creation due to the double-sided printing requirement, and 6) difficulty in uploading the computer files representing the finished cards in a uniform format to a third party for output.

U.S. Pat. No. 4,817,528, entitled “Method and Apparatus for Making Personalized Playing Cards,” describes the generation of personalized playing cards by using front and back image printing plates to print on the card stock, which is then cut to produce the cards. The card face image is comprised of a number of smaller image plates, each of a different image. By using a card face printing plates comprised of several individual image plates, the fixed cost of producing the front image printing is reduced for smaller production runs due to cost advantages related to smaller cutting dies and print plates. An additional feature involves the sequential procession of individual image plate positions resulting in the production of card decks, after being die cut, being collated such that each resultant stack of cards contains only one of each card face image.

However, the proposed invention is substantially different that the '528 patent because the proposed invention is not in any way related to efficient or cost effective printing of card decks and would not likely ever make use of the printing techniques of the '528 patent or the prior art described. The card output of the proposed invention does not in fact require this type of printing plate technology at all, as the output from the software will likely be sent directly to a computer output printer or be uploaded to a printing facility for output. Individual image/graphic or alphanumeric data placement/positioning are performed in the software.

U.S. Pat. No. 5,428,423, entitled “Photographic Printed Cards and Apparatus and Method of Making Same,” describes a method of imprinting a message on the reverse side of a photograph, either on individual photographs or continuous form photographs. These personalized messages could also be merged with mailing information, etc. for such applications as product photographs with text information of the back, greeting card comprised of the photographic front and personalized message on the back, etc.

However, the proposed invention is substantially different that the '423 patent because the proposed invention involves the insertion of any graphic or alpha-numeric “data,” which may include photographic data on either the front or back of card stock via any printer (e.g., dye sublimation, inkjet, laser, etc.), which can accept and print onto the inventor's “custom” pre-perforated card-stock. Alternately, the data can be output to any available standard card stock used by traditional printers and subsequently die cut. It does not involve the transfer of messages and other text to the back of developed photographs to produce photographic cards, as in the '423 patent.

U.S. Pat. No. 6,657,702, entitled “Facilitating Photographic Print Re-Ordering,” describes a methodology that facilitates print re-ordering, which involves encoding a photographic print with an identifier that specifies such information as the recipient, printing parameters, and any other information related to photographic print re-ordering.

However, the proposed invention is substantially different that the '702 patent because the proposed invention has nothing to do with print re-ordering and any associated re-ordering data. The proposed invention will simply allow the user to save card layouts for future use, subsequent refinement or transfer to other users of the invention and/or third-party providers, such as printers.

U.S. Pat. No. 6,623,010, entitled “Method of Building a Deck of Collectable Cards,” is a method for selecting a set of cards from a “playing deck” from a larger total card deck of collectable cards, which accommodates different “classes” of cards with specific characteristics.

However, the proposed invention is substantially different that the '010 patent because the proposed invention allows an individual to create and printout custom or personalized cards for a variety of purposes. Although there is no functionality for selecting a subset of cards from a larger collection, cards generated pursuant to the proposed invention could be used in the '010 patent (but there is no overlap in the inventions whatsoever).

U.S. Pat. No. 4,244,582, entitled “Personalized Card Pack Producing Method,” describes a mechanism for personalizing or customizing the “back” side (the non-playing elements face of the card) by utilizing photographic, photocopying or printing process requiring the use of the appropriate photographic emulsion or other sensitization process as necessary to allow for the transfer of an image to the back side of cards. Further embodiments describe the application of the custom graphics, which are adhered to the back of the card(s).

However, the proposed invention is substantially different that the '582 patent because the proposed invention provides for the customization or personalization of the face (playing element) side of each card. The '528 patent requires the user to apply the custom or personalized graphics, etc. to only the back of the card and provides no means for customizing the face (playing element) side of each card. The '528 patent is equivalent to the widespread commercially available services from various photographic developers (e.g., Walgreens), which will apply a single image to the back of each and every playing card of the entire deck (for approximately $27.00 per deck). The proposed invention goes well beyond the '582 patent in that the user is able to completely customize both sides of each card for a variety of purposes using computer generated/manipulated graphic, photographic, or alphanumeric data from a variety of sources, including scanned images, photo-CD's, digital camera image data, etc.

U.S. Pat. No. 6,646,754, entitled “Backprinting Image Prints,” describes a system/method to “backprint” image prints based on order information received specifying the recipients and associated images for each recipient. Images are first printed and then the “backprinting” information is applied to the back of each image; the system provides for an efficient method for optimized printing allowing a print order to be divided into suitable printable unit of images and further separated into print suborder sorted by recipient, then into sub-batches; thus, an order can then be scheduled and batch processed for optimal use of printing resources.

However, the proposed invention is substantially different that the '754 patent because the purpose of the proposed invention is to allow a user to generate completely custom cards for a variety of purposes. While the cards generated could potentially be printed using a system as described in the '754 patent, the proposed invention does not sort, sub-sort or manage one or more print jobs in any manner to optimize use and scheduling of printing resources.

U.S. Pat. No. 5,741,578, entitled “Artwork Comprising Overlaying Images,” describes a method for overlaying multiple images in which a first image with reflectivity characteristics is overlayed with a transparent coating with different reflectivity characteristics, thus producing artwork in which the first image is visible through the transparent coating comprising the second image yielding a separate reflected image due the differences in the reflectivity characteristics of the two image layers.

However, the proposed invention is substantially different than the '578 patent. While the proposed invention allows the user to use multiple images in the creation of the face and back of the cards, the resultant output prints are single layers deposited via the printing method of choice onto the card stock. As such, there are no multiple image layers applied, which have any variation varying reflectivity characteristics of any kind. While a printing methodology of this type could be potentially applied to the custom or personalized playing cards of the proposed invention, this is beyond the scope of the proposed invention.

U.S. Pat. No. 5,303,487, entitled “Window Display Card,” describes a window display card for consumer personalization by the placement of a display within a window, which allows viewing of the display item. One of the back flaps folds over and seals the display item, and the other back can be used for personalized writings in a manner similar to that of conventional greeting cards.

### SUMMARY OF THE INVENTION

It is an object of the present invention to provide simple and economical means to customize the front and/or back of each card, or groups of cards in a deck of standard playing cards, while maintaining the traditional locations of the card name and suit.

It is another object of the present invention to provide a simple and economical means to customize the front and/or back of each card, or groups of cards in a deck of cards for any card game or any other type of card, including various sports or other trading cards.

It is yet another object of the present invention to provide a simple and economical means to electronically share the complete information of the customized deck of cards to other users.

It is yet another object of the present invention to provide a simple and economical means to electronically share the complete information of the customized deck of cards to a commercial printer for special printing needs.

It is yet another object of the present invention to provide a simple and economical means to align and calibrate the printer by way of an alignment template, which aligns the card stock for individual printer output.

It is yet another object of the present invention to provide a simple and economical means to produce custom card deck boxes, which can uses graphic imagery similar to that of the cards themselves.

It is yet another object of the present invention to provide a simple and economical means to run the application from either a secured, interactive Internet site or on a local computer. In either case, the user would provide personal images from scanned pictures, photo CD's, digital cameras, or any other source of imagery.

In satisfaction of these and related objectives, Applicant's present invention provides a software application for the easy production of custom playing, trading, or other card sets. The user will have complete control over the layout of each card. The package allows the user to create cards for traditional poker card decks, for other games or brand new games and various trading or other cards. A common use for this software will be to create personalized poker cards where the front of the cards contains various pictures as specified by the user, e.g., pictures of one's children, family, baseball team, work group, etc. The card name and suit would likely be displayed at their traditional locations by the edges of the card. The back of the card can also display any image desired. The proposed invention also allows the user to share individual “Card Layouts” and entire “Deck Layouts” with any other users. Furthermore, if desired, there is the option for the completed Personalized Deck to be sent or uploaded to a commercial printer for special printing needs, like high volume print jobs or specialized card stock. For smaller or typical print jobs, special micro-perforated card stock is readily available so the user can print the cards on their own printers. With the supplied card stock, alignment templates are provided to facilitate alignment of each individual printer output to the card stock.

### BRIEF DESCRIPTION OF THE DRAWINGS

FIG. 1—a typical user interface screen.

FIG. 2—the front of a typical card from a standard poker deck.

For example, the King of Spades is comprised of five elements:

1) Symbols for each of the suits ( [symbol] -Clubs, “♦-Diamonds, ♥-Hearts, & [symbol] -Spades) (Items 1 & 2),

2) Alphanumeric card “values” (A—Ace, 2—10, J—Jack, Q—Queen, K—King) (Items 3 & 4), and

3) A large graphic image in the center region of each card that typically contains the image associated with the card itself (Item 5).

(Note: in FIG. 1, the center graphic is an image of a waterfall instead of the traditional graphics for a king of spades as shown in FIG. 2.)

FIG. 3—an example some of the text/graphics elements of a typical sports trading card. The front of the card may include a title (item 1), graphic image or picture (item 2), and additional text or graphic (item 3). The back of the card could include such items as the athlete's personal information (item 4), statistics (item 5) and team/league information (item 6).

Also, unlike a poker card, the layout of sports/trading cards varies significantly. A sports trading card typically has an image of the athlete either alone or with biographical information over the image. The back of the card may include an additional picture, team/league graphics, and/or statistics or other text. (A library of “typical” layouts is available in the proposed invention, which can be used “as-is,” or modified to suit the user's preferences.)

FIG. 4—“Flat” font/symbol vis-à-vis Embossed. This is an illustration of two different font and symbol “style” selections, namely, “flat” and “embossed,” which represent two different “styles” of the font/suits. When the user selects a particular “style” for the font or symbol, the package provides the option to automatically apply that “style” of font or symbol to a subset of cards or to the entire deck; this eliminates the need to populate each region of each card individually. (Note: the symbol for the suit and the alphanumeric text has been replaced by custom characters and symbols, which look reflective and embossed (or three dimensional).

FIG. 5—8.5″×11″ Micro-Perforated Card Stock Diagram for 2.5″×3.5″ cards used with the card generation package (not shown to scale).

FIG. 6—an example of the calibration sheet for 2.5″×3.5″ cards with ⅛″ rounded corners (not shown to scale).

FIG. 7—the card box interface, designed to allow the user to insert any text or graphics in any of the seven (7) regions (items 1-7). Solid lines indicate micro-perforation, and the dashed lines indicate scoring (not shown to scale).

FIG. 8—an overview of the four (4) modules; specifically, the main menu offers the user 4 choices (not counting the “end” function, each of which is described in detail in the subsequent four (4) figures below): 1) Card Layout Module, 2) Deck Layout Module, 3) Deck Population Module, and 4) Deck Output Module.

FIG. 9—Card Layout Module. This is a flow chart that describes the Card Layout module: the user can 1) create a new card layout, 2) edit an existing card layout, or 3) import or export a card layout. The card layout is not yet populated with alphanumeric characters and/or graphic images. Ultimately, the card layout information is saved to a local folder within the user's computer, or assigned an export destination.

FIG. 10—Deck Layout Module. This is a flow chart that describes the Deck Layout Module: the user can 1) create a new deck layout, 2) edit an existing deck layout, or 3) import or export a deck layout. A Deck layout is comprised of one or more Card Layouts (see FIG. 11) and has not yet been populated with alphanumeric characters and/or graphic images. Ultimately, the deck layout information is saved to a local folder within the user's computer, or assigned an export destination.

FIG. 11—Deck Population Module. This is a flow chart that describes the Deck Population Module: the user can 1) create a new personalized deck, 2) edit an existing personalized deck, 3) import or export a personalized deck, or 4) print or send the customized information to a commercial printer. In this module, a deck layout is populated with alphanumeric characters and/or graphic images. Ultimately, the personalized deck information is saved to a local folder within the user's computer, or assigned an export destination.

FIG. 12—Deck Output Module: This is a flow chart that describes the deck output module. Specifically, the user has the option to print on a local printer, share the card layouts, deck layouts or partially or fully populated customized deck information with others, and/or send the customization to a commercial printer. This flow chart describes the details of each step for each option.

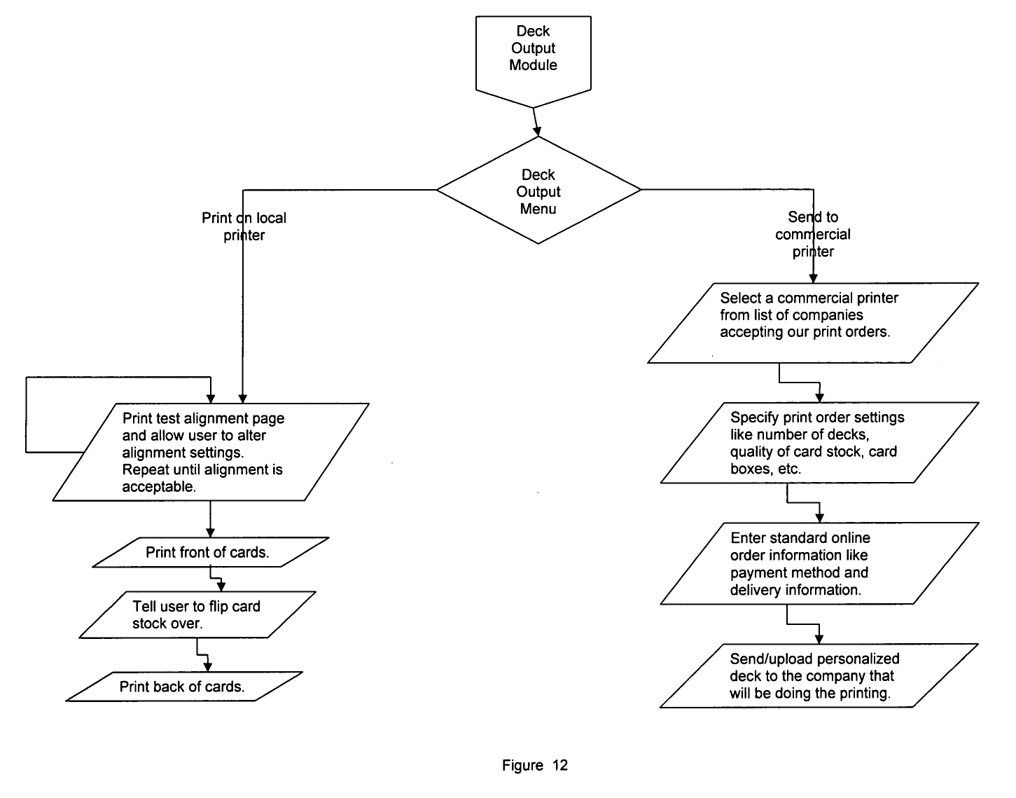

### DETAILED DESCRIPTION OF THE PREFERRED EMBODIMENT

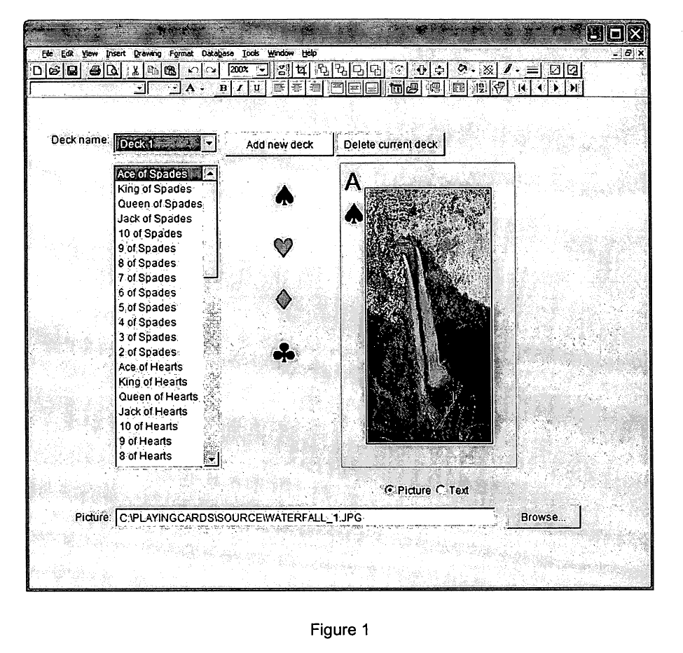

The Software. The software program of the proposed invention is currently designed but not limited to operate under the Microsoft® Windows operating system, using a graphics user interface similar to the majority of application written for this operating system. Additional versions will operate under other operating systems (e.g., Linux or Apple). The program is includes the common drop-down menus, such as “File,” Edit,” “View,” etc. In addition, task-bar buttons will be available for frequently used functions in the proposed invention. A typical user interface screen is depicted in FIG. 1.

Although the interface is similar to many application packages, the software is optimized for the creation of custom or personalized playing or trading cards. While, the example demonstrated is specific to a deck of poker cards, the card deck generation package is designed to produce not only playing cards, such as poker or pinochle decks, but also a wide range of sports, trading and flash cards, as well as completely original cards or card decks.

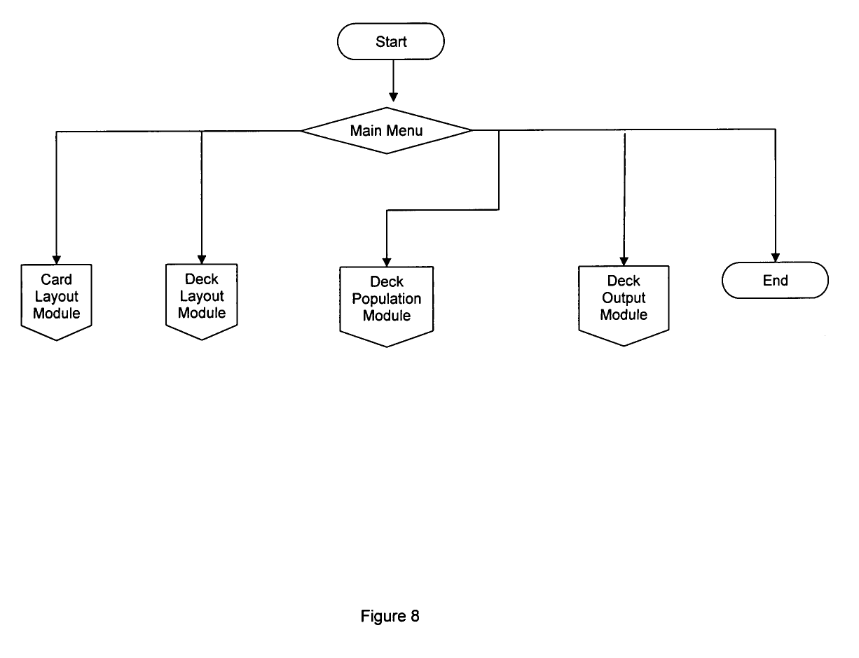

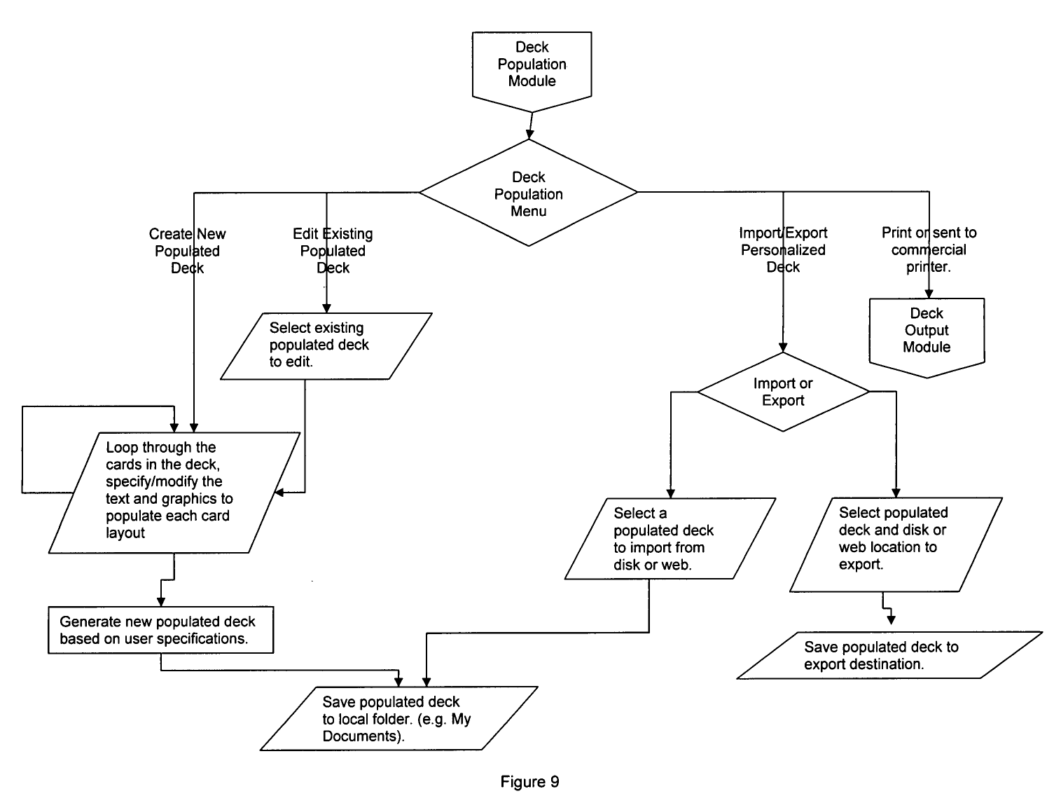

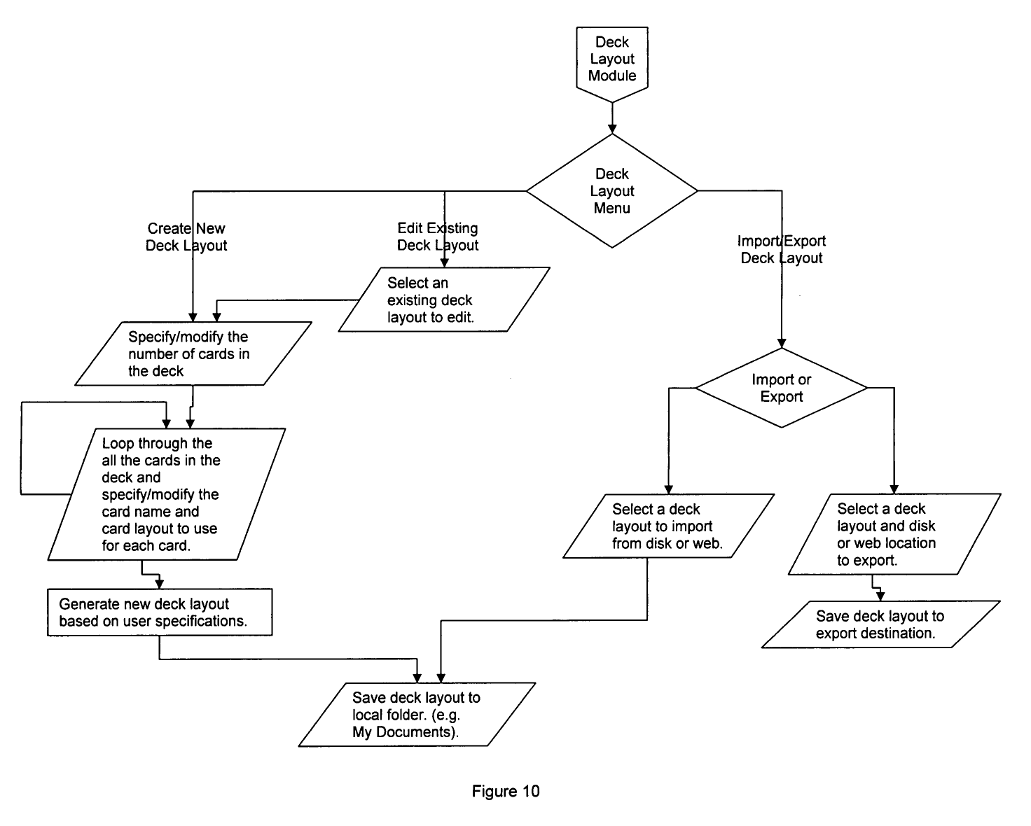

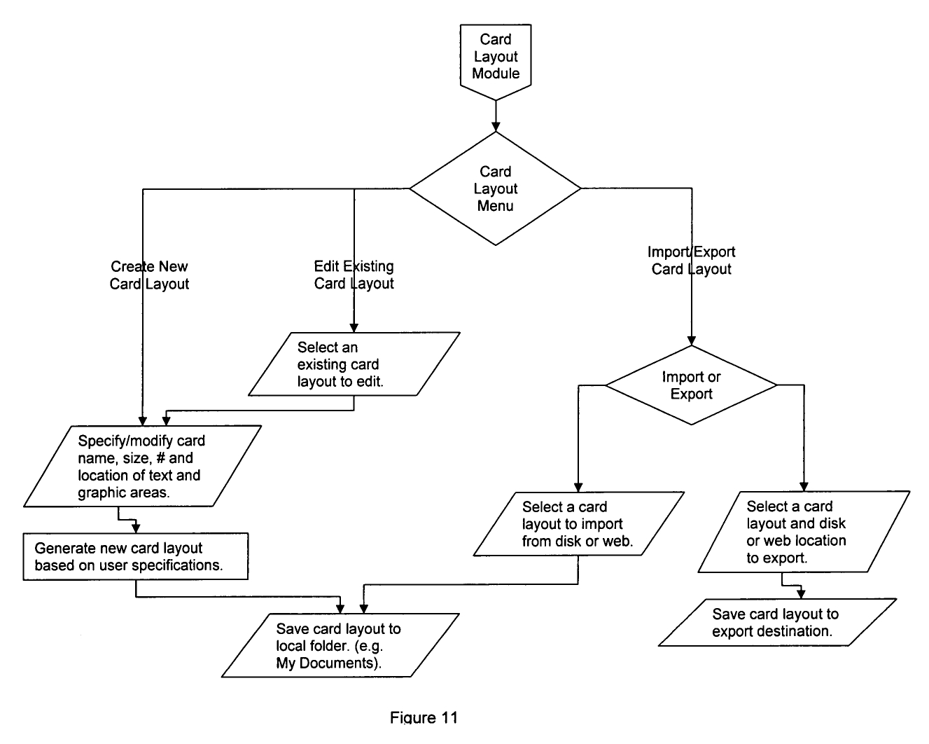

Thus, the system for creating custom or personalized card decks of the proposed invention is an economic, self-contained, stand-alone system specific to card creation and the peculiarities associated with this specific task. The program consists of four major modules: 1) Card Layout (FIG. 11), 2) Deck Layout (FIG. 10), 3) Custom Deck Population (FIG. 9), and 4) Card Deck Output Print (FIG. 8).

Card Layout of a single card. Card Layout is a description of the layout of a single card. It is composed of the size of the card and the location, orientation, and size of various graphics and text regions on the card. For example, the King of Spades in a standard poker deck would have at least two text regions: one in the upper left and the other in the lower right corner for the letter “K”. There would be two small graphic regions for the suit symbol, which in this case is a Spade. In addition, there could be a large region in the middle of the card that contains a picture of a king, or any image or text specified by the user.

The software allows for any card to be designed from scratch; however, layouts for common types of cards, e.g., Trading, Sports, Poker, etc., are provided as a starting point for the development of personalized cards and card decks as each of these types of cards are comprised of similar elements.

As illustrated in the flowchart for the Card Layout Module (FIG. 11), the user can either 1) create a new card layout, 2) edit an existing card layout, or 3) import (or export) a card layout. In this module, all the graphics/text tools required to design and edit an individual card layout are illustrated. The user specifies the card name, card size, number, size and locations of the text and graphics regions for both the front and back of each card. The new or revised card layout is then generated and subsequently saved or exported.

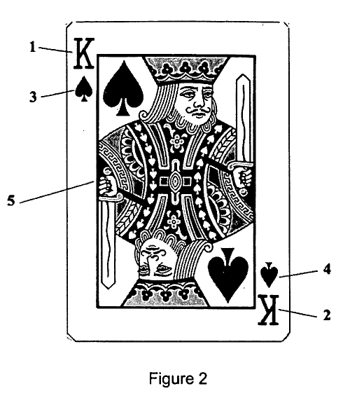

The traditional poker playing card deck is composed of 54 cards—four sets of 13 cards (Ace through King) for each suit, plus two Jokers. Each card includes the same graphic image on the back of each card and five text or graphic elements on the front of the cards. FIG. 2 depicts the front of a typical card from poker deck, the King of Spades, comprised of five elements (Symbols for each of the suits, Alphanumeric card “values”, and a large graphic image in the center region of each card that typically contains the image associated with the card itself).

For all of these graphic elements, the user can either elect to the standard graphics provided, or replace the alphanumeric characters, suits, or center graphics with alternate graphics. For example, in FIG. 1, the center graphic is an image of a waterfall instead of the traditional graphics for a king of spades as shown in FIG. 2.

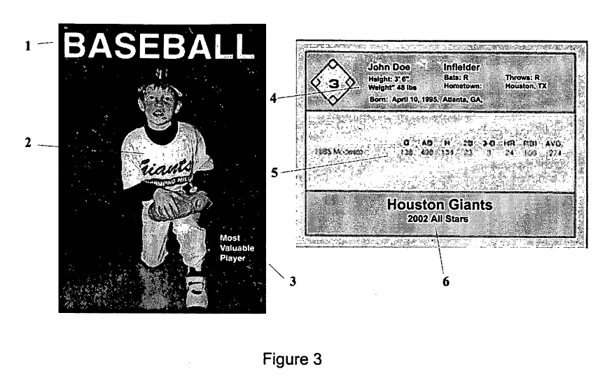

It is important to note that the user can replace the center image with a custom image, such as a personal photo. Furthermore, the user can customize the alphanumeric characters and symbols for the suits. In FIG. 3, the symbol for the suit and the alphanumeric text has been replaced by custom characters and symbols, which look reflective and embossed (or three dimensional).

### EXAMPLE 2

Sports Trading Cards. Unlike poker cards decks, the layout of sports/trading cards varies significantly. A sports trading card typically has an image of the athlete either alone or with biographical/statistical information over the image. The back of the card may include an additional picture, or team/league graphics, as well as statistics or other text. A library of “typical” layouts is available in the program of the proposed invention, which can be used “as-is” or modified to suit the user's preferences. FIG. 3 illustrates some of the text/graphics elements of a typical sports trading card. The front of the card might include a title (item 1), graphic image or picture (item 2) and additional text or graphic (item 3). The back of the card could include such items as the athlete's personal information (item 4), statistics (item 5) and team/league information (item 6).

Deck Layout (FIG. 10). The deck layout is a description of an entire deck or set of cards. It is essentially a user-defined collection of Card Layouts. It can be of any number of cards. Example 1, above, described a traditional poker deck composed of 54 Card Layouts (52 normal cards plus 2 jokers). Thus, the position and size of the alphanumeric character, suit symbols and center image areas are specified for all of the cards in the deck. The same holds for such applications as Flash Cards. In Example 2 (sports trading cards), a deck may include a layout for all of the players in a particular team or league. Of course, if the layout of each card for every member of the team is exactly the same then the Deck Layout is essentially same as the Card Layout for each player.

In the flowchart for the Deck Layout Module (FIG. 10), the user can either 1) create a new deck layout, 2) edit an existing deck layout, or 3) import (or export) a deck layout. The user can loop through the entire deck one card at a time. In this module, the user specifies the number of cards in the deck, the card names and associated card layouts. The new or revised card layout is then generated and can then be saved or exported.

Deck Population (FIG. 9). The populated deck is a combination of a Deck Layout and all the pictures and text specified by the user to fill out each Card Layout in the deck. This is the complete electronic description of the custom deck of cards, which can then be printed.

In this module, the user the user populates all of the graphics/test regions on each card in a deck or set. In Deck Population, the Deck Layout is completely populated with all of the custom or personalized pictures and text specified by the user for each Card Layout in the deck. A populated deck is a complete entire electronic description of the user's custom deck of cards, which can be exported or printed. In this module, the user can either 1) create a new custom deck from a Deck Layout, 2) edit an existing deck, or 3) import (or export) a deck. Once in a deck is opened, one can loop through the cards and select or modify the text or graphics to populate the defined regions of each card.

Equivalent regions on each card layout of the deck can be populated individually or by card groupings. For example, in the case of the sports trading cards, certain regions of the card, such as the team or league name, will be the same for each card in the deck or set. In this case, the user can specify the particular graphic or text for the same region in each of the cards. Other information, such as the individual athlete's name or picture would be populated individually or over a specific range of cards. In the example of the poker deck, one might wish to apply the same photographic image to the center region of the kings in all four suits. Thus, graphic images and/or/text are applied to a range or otherwise designated subset of the card deck. Likewise, when a symbol and/or text font “style” is selected, it can be applied to all of the equivalent regions of each card.

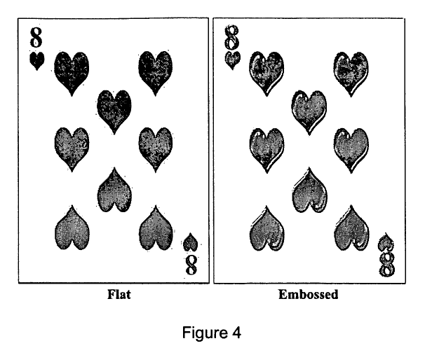

FIG. 4 shows two different font and symbol “style” selections, referred to as “flat” and “embossed,” which represent two different “styles” of the font/suits. When the user selects a particular “style” for the font or symbol, the package provides the option to automatically apply that “style” of font or symbol to a subset of cards or to the entire deck, thus, eliminating the need to populate each region of each card individually.

Deck Output (FIG. 8). Deck Layout is a description of the entire deck. It is a user-defined collection of the Card Layouts. It can be of any number of cards. For example, a traditional poker deck is composed of 54 Card Layouts (52 standard cards, plus 2 jokers).

The new or revised deck is then generated and can then be saved or exported. It is this completed deck that can be printed locally, or uploaded to a commercial printer. Local printing of the completed deck is possible through the use of special micro-perforated card stock (supplied with the software). The micro-perforation allows the user to simply remove the printed cards with smooth edges without cutting. The software enables the user to accurately print on both the front and back of the cards due to the printer alignment/calibration feature, which facilitates accurate printer output alignment with the micro-perforated card stock. Completed decks can also be shared with other software users, or can be uploaded to a commercial printer. (Commercial printers could be used for high volume, high quality, special card stock, etc.)

In the flowchart for the Deck Output Module (FIG. 8), the user can either print the completed deck locally, or upload the computer files describing the completed deck to a commercial printer that has the appropriate software to generate the finished card decks and card boxes.

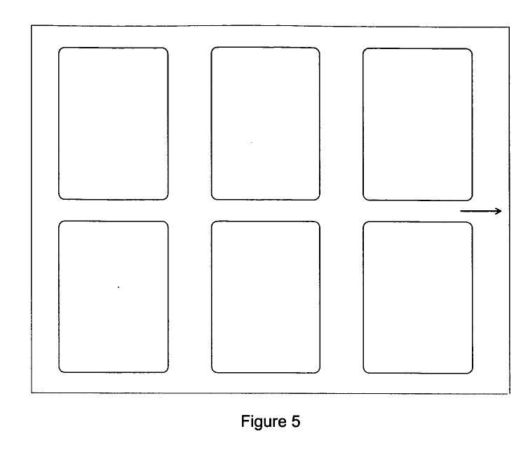

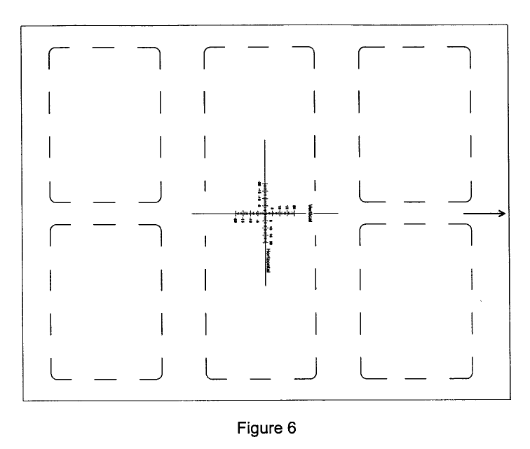

Printing locally first requires the user to use the alignment feature to correctly align and calibrate the printer output using the alignment sheets (FIG. 6) supplied with the preferred embodiment of the proposed invention. Following successful alignment/calibration, the user then correctly loads the micro-perforated card stock (FIG. 5) and prints the front of each card in the deck. The printed sheets are then turned over, ensuring the sheets are loaded in order, to print the backs of the cards.

Uploading the completed card deck file to a commercial printer requires the user to select the companies that accept the file format of the proposed invention. The user then specifies the order details, such as the number of deck, card stock selection, card deck boxes, etc. The user then enters standard online ordering information, such as name, mailing address, payment method, credit card information, etc. Following authorization/approval from the commercial printer, the completed deck file is uploaded to the commercial printer for processing.

Card Stock. The paper or card stock choice, including the finish, is important to the quality of the finished deck. Cutting the individual cards from a print sheet and subsequent “cornering” for the cards after printing requires the services of a commercial printer, which adds significantly to the cost of individual decks for small quantity of cards. Also, the card stock available at most printers lacks the appropriate characteristics to produce satisfactory results. Thus, specialized, micro-perforated card stock (FIG. 5) with a suitable finish on both sides of the material with suitable thickness and stiffness to be used in this application was developed and is included in the preferred embodiment of the proposed invention. The micro-perforation facilitates the easy removal of excess card stock after printing for smooth finishes of each card without the need for cutting. This card stock allows for printing six (6) cards per sheet on both sides using an individual's DeskJet® or LaserJet® printer, of the like.

Calibration/Alignment Sheets. In order to ensure that the individual printer output aligns accurately with the micro-perforated card stock, printer alignment calibration sheets are supplied with the card stock. These adjustments parameters include scaling (enlarging or reducing) the print output, as well as alignment (horizontal or vertical adjustment). An example of the calibration sheet for 2.5″×3.5″ cards with ⅛″ rounded corners is shown in FIG. 6. The process for calibration and alignment of the card stock is critical to the successful production of these cards, as the double-sided printing requires optimal and consistent printer output alignment. When the calibration procedure is executed, a test pattern is output to the user's printer. Red lines intercalate with the card outlines pre-printed on the calibration sheet. These red lines may fall either outside or inside the card outlines, which indicate the need to enlarge or reduce the printed output to match the calibration sheet. In addition, the printed test pattern will produce alignment indicators on the center axes, which are used to determine any required horizontal or vertical adjustment. The software of the proposed invention solicits user input as to any printer output adjustments that may be needed.

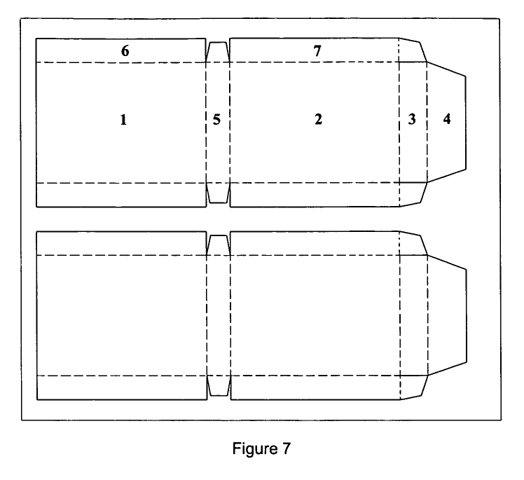

The system of the proposed invention also includes the capability to produce custom card deck boxes, which can uses graphic imagery similar to that of the cards themselves. The card box interface is designed to allow the user to insert any text or graphics in any of the seven (7) regions (items 1-7) indicated in FIG. 7. The card box design tools and card box stock allows for the printing of two boxes per 8.5″×11″ sheet (for the 2.5″×3.5″ card example) and requires only single-sided printing. The micro-perforation facilitates easy removal of excess card material with smooth edges and without the need for cutting. The scoring facilitates accurate and easy folding of the box. After printing, the user is able to easily fold and assemble the custom boxes in seconds.

The procedures described above entail card design and output from an individual computer using the software, card stock and alignment sheets provided in the preferred embodiment of the proposed invention. This description focused primarily on the generation of 2.5″×3.5″ (standard) cards and the example showed cards with (typical) ⅛″ rounded corners. It is important to note that various card stock sizes can be created other than the size described above, and card stock with square-corners is also available. Beyond the size and cornering, options, various shapes and card finishes are also available.

In addition, the application could as easily be run from an secured interactive internet site, rather than on a local computer in which case the user would provide personal images from scanned pictures, photo CD's, digital cameras, or any other source of imagery.

Also, the system could be embodied as a self-contained, interactive kiosk that contains interfaces for acquiring graphic images from various sources, such as camera memory modules, Photo-CD's or a built-in scanner. Printing could be accomplished in the kiosk and the completed deck or card sets could be provided to the user.

In addition, a simple order form could be used that allows the client to simply tag pictures and fill-out an order form that indicates what general card or deck layouts are desired, and which pictures or images are to be applied to each of the cards. The service provider could then perform the task of generating the custom card decks for a fee and deliver the completed decks to the client.

Although the invention has been described with reference to specific embodiments, this description is not meant to be construed in a limited sense. Various modifications of the disclosed embodiments, as well as alternative embodiments of the inventions, will become apparent to persons skilled in the art upon the reference to the description of the invention.

It is, therefore, contemplated that the appended claims will cover such modifications that fall within the scope of the invention.

I claim:

1. A computer program for facilitating the production of customized playing or trading cards comprising:
first computing means for displaying on display means of an interfaced computer means a first graphical user interface which includes a first graphical depiction of a first face of a first playing card, said first graphical depiction including depictions of a first user-definable graphical field;
second computing means for displaying a second graphical user interface which includes a user-selectable menu representative of digitized graphical images stored in memory means operably interfaced with said computer;
third computing means for receiving user-input for selecting a said graphical image for depiction in said first user-definable graphical field of said first graphical depiction.

2. The computer program of claim 1 further comprising:
fourth computing means for transmitting to printer means which are interfaced with said computer means commands for printing a physical embodiment of said first graphical depiction.

3. The computer program of claim 1:
wherein said first computing means is further configured for displaying on display means a third graphical user interface which includes a second graphical depiction of a second face of a second playing card, said third graphical depiction including depictions of a second user-definable graphical field; and
wherein said third computing means is further configured for receiving user-input for selecting a said graphical image for depiction in said second user-definable graphical field of said second graphical depiction.

4. The computer program and associated computer means of claim 3 further comprising:
fourth computing means for transmitting to printer means which are interfaced with said computer means commands for printing a physical embodiment of said first graphical depiction.

5. A computer program for facilitating the production of customized playing or trading cards comprising:
first computing means for displaying on display means of an interfaced computer means a first graphical user interface which includes a first graphical depiction of a first face of a user-selectable one of a plurality of playing or trading cards, said first graphical depiction including depictions of a first user-definable graphical field;
second computing means for displaying a second graphical user interface which includes a user-selectable menu representative of digitized graphical images stored in memory means operably interfaced with said computer;
third computing means for receiving user-input for selecting a said graphical image for depiction in said first user-definable graphical field of said user-selectable first graphical depiction; and
fifth computing means for storing for later retrieval data representative of a user's selection of each said digitized graphical image in relation to each said user definable graphical field of each said user-selectable one of a plurality of playing or trading cards.

6. The computer program of claim 1 further comprising:
fourth computing means for transmitting to printer means which are interfaced with said computer means commands for printing physical embodiments of one or more of said first graphical depictions of respective said first face or faces of said plurality of playing or trading cards.

7. The computer program of claim 5:
wherein said first computing means is further configured for displaying on display means a third graphical user interface which includes a second graphical depiction of a second face of user-selected one of a plurality of playing or trading cards, said third graphical depiction including a depiction of a second user-definable graphical; and
wherein said third computing means is further configured for receiving user-input for selecting a said graphical image for depiction in said second user-definable graphical field of said second graphical depiction.

8. The computer program of claim 7 further comprising:
fourth computing means for transmitting to printer means which are interfaced with said computer means commands for printing physical embodiments of one or more of said first graphical depictions of respective said first face or faces of said plurality of playing or trading cards.
